(19) United States
(12) Patent Application Publication
(10) Pub. No.: US 2002/0116225 A1
(43) Pub. Date: Aug. 22, 2002

(54) Tracking and reporting client outcome

(76) Inventors: Margaret Morse, Newton, MA (US); Christopher Mundy, Millis, MA (US); Madeline Becker, Waltham, MA (US); Susan Warning, Kansas City, MO (US); Anthony Zipple, Somerville, MA (US); Susan Morse, Waltham, MA (US)

Correspondence Address: TESTA, HURWITZ & THIBEAULT, LLP, HIGH STREET TOWER, 125 HIGH STREET, BOSTON, MA, 02110, US

(21) Appl. No.: 09/788,633

(22) Filed: Feb. 15, 2001

(51) Int. Cl. G06F 17/60

(52) U.S. Cl. 705/3; 705/2; 705/10

(57) ABSTRACT

A server facilitates access to patient information by providing a graphical user interface to appear on a single display screen on a user's computer. The graphical user interface enables the user to select a patient for which patient information is to be displayed. The server displays categories of patient information in response to the user selection of a patient and enables the user to select a category. Upon such a selection, the server displays on the graphical user interface information pertaining to the selected patient and corresponding to the selected category.

### FIELD OF THE INVENTION

This invention relates generally to accessing patient information, and more specifically to tracking and reporting client outcomes as a human service provider.

### BACKGROUND OF THE INVENTION

Health care costs currently represent a significant portion of the United States Gross National Product, and continue to rise at an exceptional pace. A significant portion of these increased costs results from an inability to appropriately retrieve, coordinate, or target relevant t information (e.g., medications, current treatment, past treatment, medical history, personal information) of a particular patient. This problem increases further when patients receive services from multiple health service providers, or different locations of the same provider. For example, an employee of a health service provider generally spends more time and experiences more confusion when attempting to access information about a particular patient who has transferred from one health service provider location to another.

Against this backdrop, methods and systems of tracking and reporting client or patient “outcomes” have developed. Client outcomes track the progress of patients over time, e.g., as they undertake a particular course of treatment. Largely, health service providers use computer networks to track and report these client outcomes. Health service providers conventionally display a list of options (e.g., medical information, financial information, company information) on an introductory display screen accessible to employees responsible for monitoring or entering data relevant to patient outcomes. Generally, the user of the computer network may not obtain information about a particular patient from this introductory display screen and, indeed, may be unable even to select a patient from this screen.

Instead, the user generally accesses information relating to a particular patient from windows and/or display screens appearing in response to one or more selections made by the user. Frequently, to access a specific piece of information (not necessarily medical information) relating to a particular patient, such as the voting status of the patient, the user may have to weave through multiple windows and/or display screens before a window finally prompts the user for a particular patient name. Further, non-medical information such as voting status may not even be available in such conventional systems.

Suppose, for example, that the user is interested in viewing medical information relating to a particular patient. On a conventional system, the user first selects “medical information” from a list of options. The user may then be asked to select a particular health service provider and perhaps even a specific location of that provider before being able to specify the patient of interest. If, after viewing the patient's medical information, the user then would like to view the patient's financial information, it may be necessary to backtrack through a “tangled web” of visited windows and screens before arriving at the introductory display screen, where the user may select the “financial information” option. Then, once again, the user may have to navigate through various screens and selections. This process is cumbersome, inefficient, and confusing.

Accordingly, it is desirable to produce a system that is capable of simplifying access to patient data, e.g., data relevant to tracking of client outcomes. More specifically, it is desirable to produce a system that can track and report client outcomes while enabling a user to access information relevant to those outcomes from a single display screen. Users of a client outcome system typically want access to patient information without browsing through multiple windows and screens of other information before retrieving the needed information corresponding to a particular patient.

### DESCRIPTION OF THE INVENTION

Brief Summary of the Invention

The present invention enables a user to more efficiently access patient information. The user is spared the need to browse redundantly through windows and screens in order to access different items of information about a particular patient.

In a first aspect, the invention facilitates access to patient information by providing a user's computer with a graphical user interface that appears on a single display screen. A user can display information relating to a particular patient by selecting that patient from a group of patients. In response to the user's selection of the patient, several categories of information relevant to that patient are displayed on the user interface. Once the user selects the category of patient information to display, the interface displays particular items of information relating to the selected patient and corresponding to the selected information category.

For example, categories that the user can select for display may include demographic information about the patient, financial information, or information about parties who can be contacted in case of an emergency associated with the patient. Once the user selects a category (e.g., “Demographics”), the user interface can display patient information relevant to that category (e.g., residential information, the primary language spoken by the patient, the voting status of the individual, and/or the medical information of the patient).

In a preferred embodiment, the interface includes markup instructions generated on a server in communication with a client computer. In addition, the server may maintain a database of patients and patient information. The client computer generates the interface by executing the markup instructions received from the server. In operation, the client computer may communicate a request made by the user to the server; the server receives and handles the user request; then transmits the requested information, along with markup instructions, back to the client computer for display.

Some user selections are executed locally, on the client machine, while others prompt a request to the server. How particular actions are handled is largely a matter of design choice. For example, a list of patient names accessible to the particular user may be transmitted to the is client computer along with the markup instructions, thereby facilitating local access to these names. Alternatively, the list may be retained at the server and transmitted to the client computer only in accordance with user requests that are processed by the server (e.g., the user selects a letter of the alphabet, and the server transmits a list of patients whose last names begin with the selected letter).

In a second aspect, a server facilitates access to patient information by connecting to a computer network with a network interface. The server includes a module for providing a first set of instructions that are executable on a client computer. The instructions enable a graphical user interface to appear on a single display. The user interface enables a user to make selections on the client computer and this computer transmits these selections to the server. The server also includes a transaction module that handles these requests transmitted by the client computer. The instructions further enable a user to select a patient on the user interface. In response to this selection, the interface displays several categories of patient information relating to the selected patient. In response to the selection of a category, the client computer then displays on the user interface patient information concerning the selected patient and corresponding to the selected information category.

### BRIEF DESCRIPTION OF THE DRAWINGS

Advantages of the present invention will become better understood by referring to the following drawings, which show a system according to an illustrative embodiment of the invention and in which:

FIG. 1 is a conceptual block diagram depicting an embodiment of a computer system that tracks and reports client outcomes constructed in accordance with an illustrative embodiment of the invention;

FIG. 2 is a high-level organizational block diagram illustrating an embodiment of the computer system of FIG. 1 in communication with multiple remote locations;

FIG. 3 is a flow diagram depicting an illustrative operation of the steps performed to enter patient information into the computer system of FIG. 1;

FIG. 4 is a more detailed flow diagram depicting an embodiment of the operation of the computer system of FIG. 1;

FIG. 5A is an illustrative embodiment of a display screen constructed in accordance with the invention; and

FIG. 5B is an illustrative embodiment of a display screen having demographic information relating to a particular patient.

### DESCRIPTION OF THE ILLUSTRATIVE EMBODIMENTS

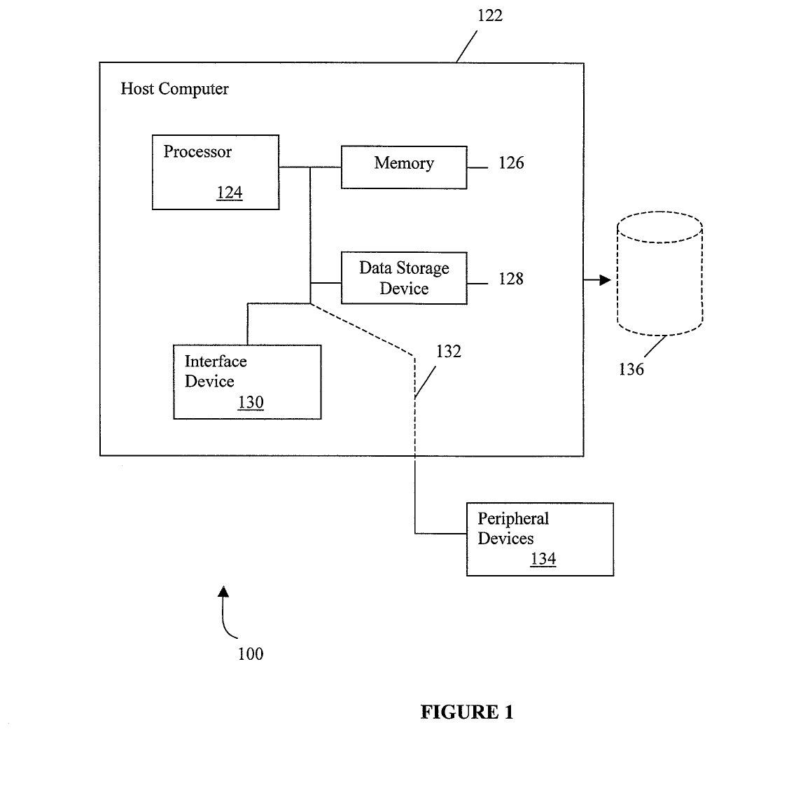

FIG. 1 is a conceptual block diagram depicting an exemplary computer system 100 that tracks and reports outcomes of individuals. The illustrative computer system 100 includes a “host” or server computer 122 having a processor 124, a memory 126 for storing programs and/or data, a data storage device 128 (e.g., a hard disk or CD-ROM drive), and an interface or network device 130. Interface device 130 allows host computer 122 to communicate with “client” computers over a computer network (such as the Internet). More specifically, the interface device 130 may support communications over a local-area network (LAN), a medium-area network (MAN), or a wide area network (WAN) such as the Internet or the World Wide Web in accordance with conventional, well-known protocols.

In one embodiment, the various components 124-130 communicate over a bi-directional address/data bus 132 (hereafter referred to as a communications bus 132). The host computer 122 can additionally be in communication with a peripheral device 134. The peripheral device 134 can include, without limitation, a visual display device (e.g., a computer monitor), a data entry device (e.g., a keyboard), a mouse, a sound-producing device (e.g., speakers), a sound-input device (e.g., microphone), a printer, and the like. In yet another embodiment and as described below, the host computer 122 is in communication with a database management system (DBMS) 136.

The capabilities of host computer 122 depend on the application, anticipated usage burden, minimum response requirements, and the like. Suitable server platforms are readily available and known in the art.

The memory 126 can include, without limitation, a volatile memory component (e.g., random access memory), a non-volatile memory component (e.g., read-only memory), and a non-volatile random-access memory (i.e., NVRAM). The volatile memory component may couple with the communications bus 132 for storing information and instructions for the processor 124. The non-volatile memory typically couples with the communications bus 132 for storing static information and instructions for the processor 124. Collectively, memory 126 provides an operating system and application instructions for executing the functions herein described.

The DBMS 136, often called the “back end” tier of a computer system 100, stores and manages data, in particular the patient information that is the subject of the present invention. DBMS may reside within the server 122 (e.g., as a hard drive array) or may instead reside on a separate device or devices (e.g., a storage area network) accessible to server 122 via network interface 130.

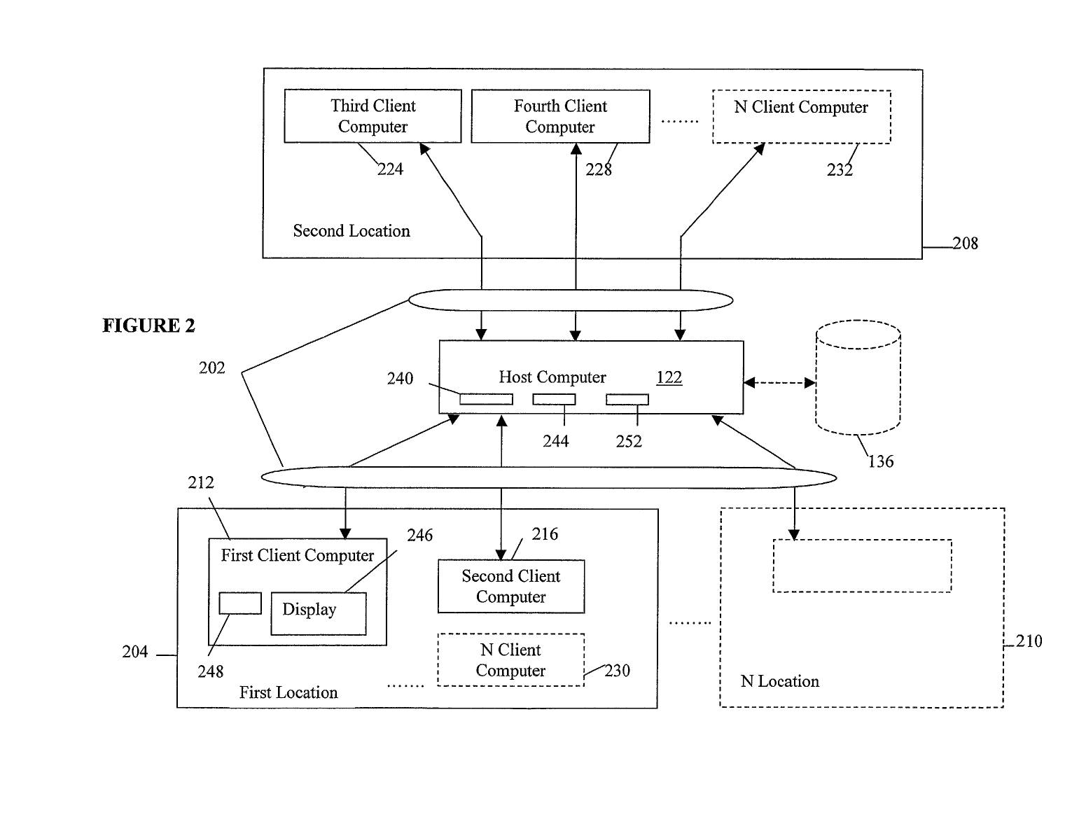

FIG. 2 depicts a high-level organizational block diagram illustrating an embodiment of the computer system 100 in communication with multiple remote locations, or sites, over a computer network 202. In more detail, the network 202 includes a first location 204 and a second location 208. Although the computer network 202 illustrated in FIG. 2 and described below is shown with two locations 204, 208, this is solely for ease of illustration, and any number of locations (shown as shadow N location 210) may be included in the invention.

The first location 204 includes a first client computer 212 and a second client computer 216. The second location 208 includes a third client computer 224 and a fourth client computer 228. Additionally, the first location 204 and/or the second location 208 may include any number N of client computers (shadow clients 230, 232). Furthermore, although the description below focuses on the operation of the invention on the first client computer 212 at the first location 204, the description applies to any of the client computers 212-232 at any location 204, 208, 210.

In one embodiment, the host computer 122 further includes an instructions module 240 and a transaction module 244. The modules 240, 244 can be written in any programming language and/or scripting languages, such as, but not limited to, Java, JavaScript, Visual Basic, C++, HTML, and the like. (The instructions module 240 and the transaction module 244 may alternatively be included in a single module.) In a representative transaction, a request for patient information transmitted from client computer 212 is received by server 122 and processed by transaction module 244, which may, for example, verify the identity of the requester and determine the scope of information the requester is entitled to access; this validation procedure may involve lookup of a database record associated with the requestor and stored in DBMS 136. The instruction module 240 thereupon generates a first set of instructions and transmits these to the client computer 212 over the network 202. The first client computer 212 executes these instructions to provide the graphical user interface on a single display screen appearing on a display 246 to the user operating the first client computer 212. As described in more detail below, the graphical user interface enables the user to make selections on the first client computer 212. The first client computer 212 then transmits these selections to the server as user requests.

The client computer 212 may additionally include a first security module 248 to encrypt transmissions to the server computer 122. If the client computer 212 encrypts the user requests, the server computer 122 then includes a second security module 252 to decrypt such transmissions over the network 202. For example, the first security module 248 may encrypt requests with an encryption key that is available to the public (i.e., public key). Although the public key is available to the public, a request encrypted with the public key may only be decrypted using a particular private key, which is not available to the public. The server computer 122 typically includes the corresponding private key to decrypt the encrypted user requests.

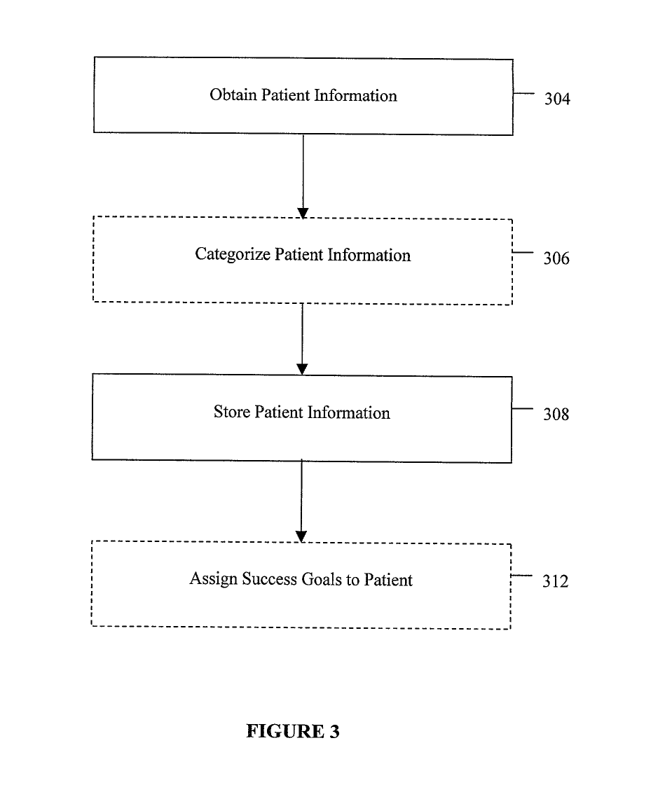

FIG. 3 broadly illustrates an example of the steps performed to record a wide range of information using the computer system 100. The server computer 122 initially obtains (step 304) patient information relating to a patient from a patient registration form. Alternatively, the patient may provide the information to the server computer 122 over the network 202 (e.g., an Internet-based patient registration form). The patient could also provide the corresponding patient information to the server computer 122 as a voice message (e.g., a telephone call to an automated telephone answering service, an answering machine message). In this case, the server computer 122 translates the patient information into recognizable data that the server computer 122 can interpret. In another embodiment, a user of the server computer 122 inputs the information into the server computer 122.

In one embodiment, the server computer 122 then categorizes (step 306) the patient information. The client registration form may have previously categorized the patient information, in which case the server computer 122 can proceed to the following step. However, if the patient transmits the information to the server computer 122 via a message on an answering machine, the server computer 122 first may convert the information into a recognizable format (i.e., bits) and then may categorize the information.

In particular, the patient information can include, without limitation, the patient's name, address, salary, date of birth, medical history, current medications, race, telephone number, primary language spoken by the patient, family relatives, person to contact in case of an emergency, voter information (e.g., registered to vote), and the like. If the patient transmits this information to the server computer 122 in an unformatted fashion, the server computer 122 organizes the information into specific categories.

For instance, the server computer 122 may support (e.g., create within DBMS 136) a first category, called “Demographics”, which can include the name, address, date of birth, and social security number of the patient. The server computer 122 may also support a second category, such as “Financial”, which would include the patient's salary. Indeed, the server computer 122 could even support sub-categories, such as “Basic” and “Personal Identity” as two sub-categories under the “Demographics” grouping. Under the “Basic” sub-category, the server computer 122 might store the patient's name, address, telephone number, and date of birth. Under the “Personal Identity” sub-category, the server computer 122 could store the patient's race and primary language spoken by the patient. Similar to the categories and patient information associated with the selected patient, the sub-categories are displayed on the graphical user interface appearing on the single display screen.

Moreover, the server computer 122 may categorize the information associated with each patient differently. In one embodiment, the server computer 122 tailors the categories in response to particular users and/or particular patient information. In further embodiments, the server computer 122 categorizes all patient information related to patients associated with the first location 204 differently from the way it categorizes the patient information for patients associated with the second location 208.

The server computer 122 then stores (step 308) the patient information. For example, the server computer 122 may store the patient information in the DBMS 136. The server computer 122 may store the information in the memory 126 for expeditious retrieval during an information acquisition session. The server computer 122 may also store the information on the data storage device 128. In other embodiments, the server computer 122 could transfer the information from any of the above devices 126, 128, 136 to any other device 126, 128, 136 for storage.

Once the server computer 122 stores the patient information, the server computer 122 may, if desired, assign (step 312) success goals to the patient. For example, if the patient information states that the patient typically smokes four packs of cigarettes per day, the server computer 122 may assign a specific date for that patient to decrease his cigarette intake to three packs of cigarettes per day. The server computer 122 may plan a routine over a certain time frame for the patient to incrementally decrease the number of packs of cigarettes that the patient smokes per day. Once the server computer 122 plans such a routine, the server computer 122 stores this routine (e.g., in the DBMS 136) for retrieval by a user request.

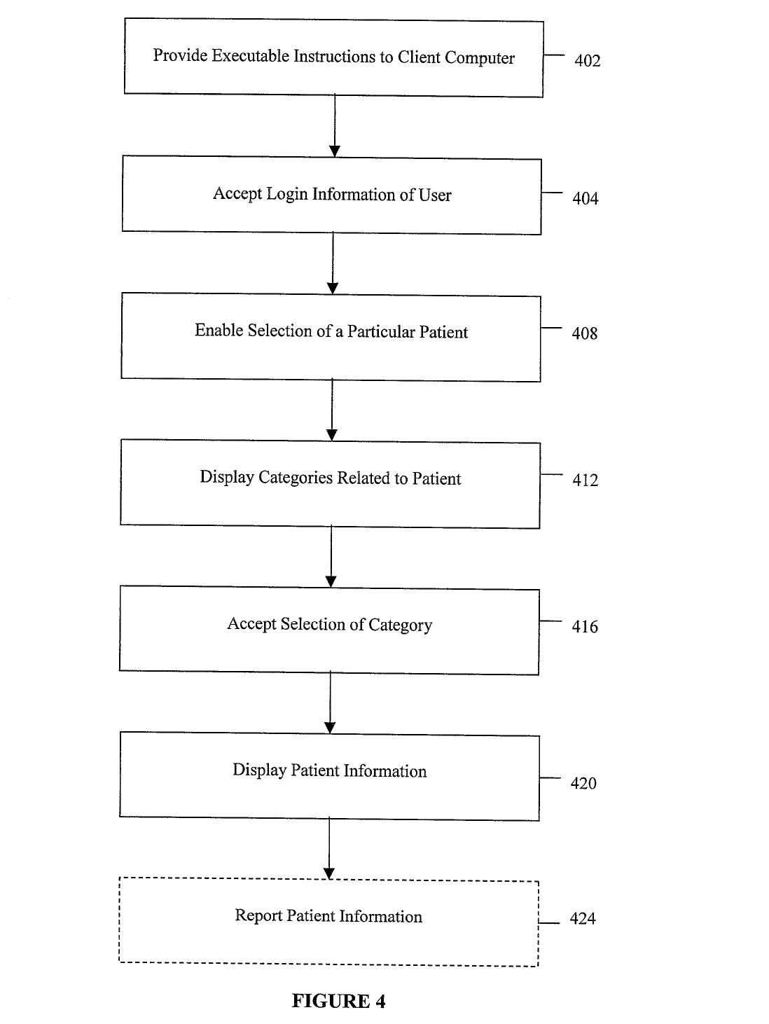

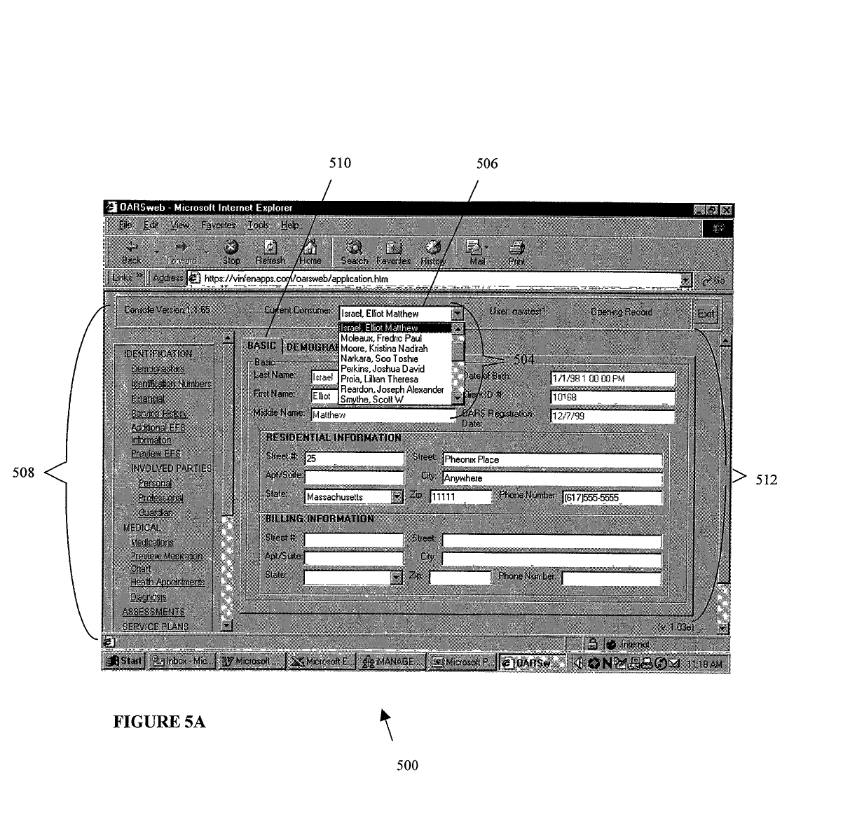

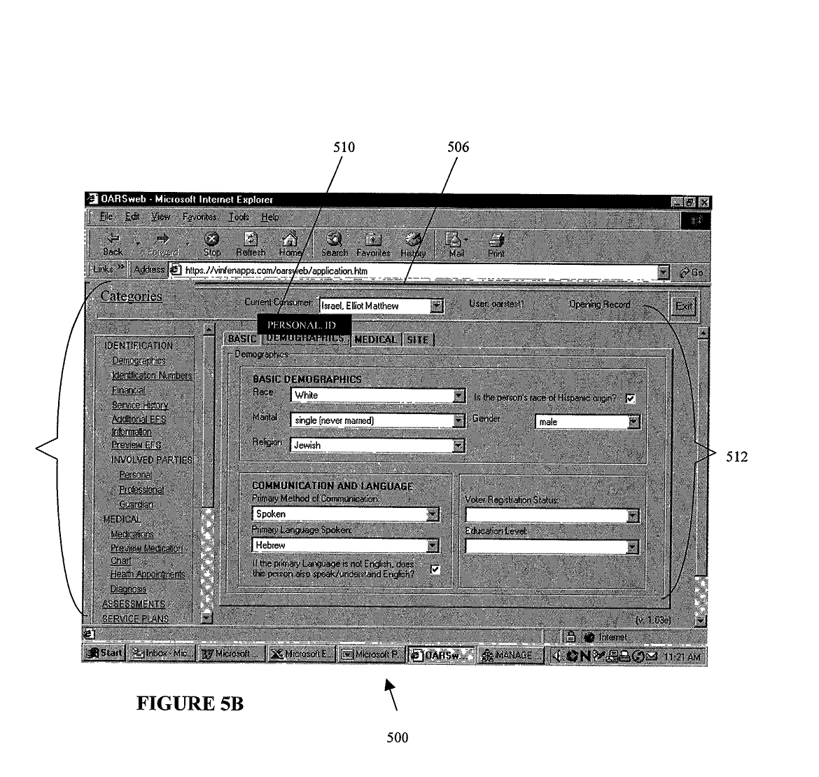

Referring to FIGS. 4 and 5A, the server computer 122 provides (step 402) a set of executable instructions, as described above, to the first client computer 212 over the network 202. Following the execution of these instructions, the first client computer 212 renders a graphical user interface 500 appearing on the single display screen of display 246. As described above, the server computer 122 typically requires the user to transmit login information to the server computer 122 before enabling access to the patient information and/or the categories associated with the patient information.

The server computer 122 accepts (step 404) the login information from the user and subsequently enables (step 408) the user to select (on the graphical user interface 500) a patient for the display of information relating to the selected patient. Typically, the server computer 122 transmits a list of available patients 504 to the first client computer 212 over the network 202. The client computer 212 displays the patient list 504 to the user on the graphical user interface 500.

Once the user selects a patient, the first client computer 212 transmits this selection (i.e., a user request) to the server computer 122. The server computer 122 receives the user request and consequently displays (step 412) categories 508 of patient information relating to the patient, as described above, on the same graphical user interface 500 as the display of the list of patients 504. Therefore, the user has access to information related to each category 508 and corresponding to each patient 504 on the same graphical user interface 500 (i.e., on the single display screen shown in FIG. 5A and appearing on the display 246 shown in FIG. 2).

The user then selects a particular category 508 and the first client computer 212 transmits the user request to the server computer 122. The server computer 122 accepts (step 416) the user's selection of the category 508 and, in response to the user request, displays (step 420) information concerning the selected patient 506 and corresponding to the selected category on the same graphical user interface 500. Thus, unlike the typical system in which a user typically weaves through multiple windows to obtain a specific piece of information relating to a patient, the user can access the information relating to a patient 506 and corresponding to a category 508 with the graphical user interface 500 appearing on a single display screen.

Further, the user interface 500 can display sub-categories 510 of the selected category 508 as screen tabs. For instance, the server computer 122 displays the patient information 512 (e.g., residential information, billing information), as shown in FIG. 5A, about a selected patient “Elliot Matthew Israel” following the user selecting the “Demographics” category 508 and subsequently selecting the “Basic” sub-category 510.

The server computer 122 can also support a search for a particular patient living on a specific street by using the street name as the searching field. For example, a user may request the server computer 122 to display on the graphical user interface 500 the patient information for any patient living on “Phoenix Place”. As shown in FIG. 5A, the street name and street number of the selected patient's address are separate fields and can each be used independently by the server computer 122 to retrieve information about a patient 506 associated with a particular user request. Further, any field within the patient information 512 displayed on the graphical user interface 500 can be used to search for the patient information 512 about a particular patient.

Additionally, the server computer 122 or the client computer 212 can report (shadow step 424) the patient information 512. In response to a user request for a report, the server computer 122 can generate a report of the selected patient 506, categories 508, sub-categories 510, and patient information 512 relating to the patient 506 and transmit the report to the client computer 212 (e.g., for display on the graphical user interface 500). Alternatively, the client computer 212 can generate a report of the selected patient 506, categories 508, sub-categories 510, and patient information 512 relating to the patient 506. Following the receipt or generation of the report, the client computer 212 can output (e.g., to a printer, to speakers) the report for subsequent review, analysis, documentation, and the like.

The report may be an emergency fact sheet that provides information about parties to contact in case of an emergency with respect to the patient. The report may also be a question and answer report, which provides the patient's responses to questions asked to the patient (e.g., on the client registration form). The report may also be a medication chart to provide the user with the current medications taken by the patient. The report may additionally be a service plan report, which provides information on the current treatment plan that the health service provider to plans to provide to the selected patient.

The service plan report can additionally be used to track the success of the success goals assigned to the patient. More specifically, a user of the client computer 212 can output the service plan report and analyze the report to determine whether the current treatment for the patient is adequate (i.e., if the assigned goals are being accomplished by the patient). In another embodiment, the client computer 212 (or the server computer 122) automatically tracks the success of the assigned success goals by comparing the service plan report to an expected success rate. An expected success rate may vary for each patient.

In other embodiments, the server computer 122 provides different layers of permission for each user. For instance, the server computer 122 may only allow a particular user to view a predefined list of patients 504, predefined categories 508 relating to a selected patient 506, predefined sub-categories 510 of the category 508, and/or predefined fields of patient information 512. Moreover, the server computer 122 may enable a user to only view the patient information 512 without having the ability to change the patient information 512 (i.e., read/write permission). It should be noted that the server computer 122 can have any number of permissions relating to each user to limit or expand the user's ability to view, manipulate, and analyze the patient information 512 associated with different patients. As described above, this functionality may be implemented by the transaction module 244.

FIG. 5B illustrates an exemplary screen shot of the same graphical user interface 500 following the selection of the “Personal ID” sub-category 510 after the selection of the “Demographics” category 508. The “Personal ID” sub-category 510 displays the patient's race, marital status, religion, primary language spoken by the patient, and the like on the same graphical user interface 500.

Although the present invention has been described with reference to specific details, it is not intended that such details should be regarded as limitations upon the scope of the invention, except as and to the extent that they are included in the accompanying claims.

What is claimed is:

1. A method for accessing patient information, said method comprising the steps of:
providing a graphical user interface appearing on a single display screen;
enabling a user to select, on said interface, a patient for which patient information is to be displayed;
in response to user selection of a patient, displaying to said user on said interface a plurality of categories of patient information relating to said patient and enabling said user to select from among said categories; and
in response to selection of a category, displaying, on said interface, information concerning said selected patient and corresponding to said selected information category.

2. The method of claim 1 wherein said interface comprises markup instructions generated on a server in communication with a client computer operated by said user, wherein (a) said server maintains a database of patients and said patient information, (b) said markup instructions are executable on said client computer to generate said interface thereon, and (c) said interface responds to user selections by transmitting, to said server, requests corresponding thereto and displaying information returned by said server.

3. The method according to claim 1 wherein the patient is associated with a plurality of locations and further comprising the step of facilitating retrieval of information relating to the patient and any of the associated locations.

4. The method of claim 1 further comprising the step of accepting at least one of (a) a user name associated with said user and (b) a password associated with said user prior to enabling said user to select a patient.

5. The method of claim 6 fuirther comprising the step of obtaining said patient information within a predetermined period of time.

6. The method of claim 1 wherein said information concerning said selected patient and corresponding to said selected information category further comprises information relating to at least one of medication, assessment, and treatment plan ratings.

7. The method of claim 1 wherein said information category further comprises at least one of demographic information, identification number, financial information, and service history.

8. The method of claim 7 further comprising the step of enabling said user, in response to user selection of demographic information and on said graphical user interface, any of basic patient information, communication information, medical information, and information relating to said plurality of locations.

9. The method of claim 8 wherein said communication information further comprises primary language spoken by said patient.

10. The method of claim 8 wherein said basic patient information further comprises residential information.

11. The method of claim 1 wherein said information category fuirther comprises information related to at least one involved party associated with said particular patient.

12. The method of claim 11 further comprising the step of enabling said user to access at least one of personal information, professional information, and guardian information.

13. The method of claim 1 further comprising the step of enabling said user to access diagnosis information relating to said particular patient.

14. The method of claim 1 wherein said categories comprise success goals assigned to said particular patient.

15. The method of claim 14 further comprising the step of tracking achievement of said success goals.

16. The method of claim 1 wherein said interface enables generation of at least one report concerning the selected patient.

17. The method of claim 16, wherein said report is at least one of an emergency fact sheet, a medication chart, a question and answer report, and a service plan report.

18. The method of claim 2 further comprising the step of enabling said client computer to communicate with said server over a secure communication channel.

19. The method of claim 1 wherein said interface is configured to enable said user to modify said patient information.

20. The method of claim 1 wherein said interface is configured to enable said user to delete said patient information.

21. The method of claim 1 further comprising the step of enabling said user to access voter information of said particular patient.

22. The method of claim 1 further comprising the step of enabling said user to search for said particular patient with a field of said patient information.

23. The method of claim 1 further comprising the step of providing at least one layer of permission for said user.

24. The method of claim 23 further comprising enabling said user to select said patient from a predefined list of patients.

25. The method of claim 23 further comprising enabling said user to select said category from predefined categories.

26. The method of claim 23 further comprising limiting said user to viewing said patient information.

27. A method of facilitating access to patient information, said method comprising the step of providing to a user's computer, via a computer network, a first set of executable instructions causing said user's computer to render a graphical user interface appearing on a single display screen, said interface (a) enabling a user to select, on said interface, a patient for which patient information is to be displayed, (b) in response to user selection of a patient, displaying to said user a plurality of categories of patient information relating to said patient and enabling said user to select from among said categories, and (c) in response to selection of a category, displaying, on said interface, information concerning said selected patient and corresponding to said selected information category.

28. A server for facilitating access to patient information, said server comprising:
a network interface for connecting to a computer network;
a module for providing a first set of instructions executable on a client computer to render a graphical user interface appearing on a single display screen, said user interface enabling a user to make selections on said client and transmitting said selections to said server; and
a transaction module for handling user requests received from said interface executing on said client computer,
said instructions, when executed on said client computer, (a) enabling a user to select, on said user interface, a patient for which patient information is to be displayed, (b) responding to user selection of a patient by displaying to said user a plurality of categories of patient information relating to said patient and enabling said user to select from among said categories, and (c) in response to selection of a category, communicating with said transaction module via said network and subsequently displaying, on said interface, information returned to said client by said transaction module server concerning said selected patient and corresponding to said selected information category.
